(19) United States
(12) Patent Application Publication
(10) Pub. No.: US 2010/0116735 A1
(43) Pub. Date: May 13, 2010

(54) METHOD OF MONITORING AND CONTROLLING BIOLOGICAL ACTIVITY IN BOILER CONDENSATE AND FEEDWATER SYSTEMS

(76) Inventors: F. Philip Yu, Aurora, IL (US); Deborah M. Bloom, Wheaton, IL (US)

Correspondence Address: Peter A. DiMattia;Patent and Licensing Department, Nalco Company, 1601 West Diehl Road, Naperville, IL, 60563-1198, US

(21) Appl. No.: 12/269,991

(22) Filed: Nov. 13, 2008

(51) Int. Cl. C02F 1/68

(52) U.S. Cl. 210/632

(57) ABSTRACT

A method of monitoring and optionally controlling the biological activity in a boiler condensate and/or feedwater system is disclosed. The methodology involves looking at the amount of ATP in a boiler fluid.

### FIELD OF THE INVENTION

The field of this invention pertains to monitoring and controlling biological activity in a boiler system.

### BACKGROUND OF THE INVENTION

Historically, it has been very difficult to detect significant microbial population in condensate systems, except for visible pluggage in pump strainers, polishers, and return tanks. Such fouling requires an enormous amount of plant operator time to dismantle, clean, and reassemble affected equipment.

Conventional methods to address microbial fouling have involved collecting a water sample from a holding tank of a condensate return line in a boiler system and then transferring it to a laboratory to perform plate enumeration. Several different culture media are normally used to allow the indigenous microorganisms to grow either under an aerobic or an anaerobic environment. The microbial population is then determined by colony formation on a Petri dish(es). Due to the dramatic differences in the conditions between the laboratory and the feedwater or condensate piping system, the culture method usually does not detect microbial growth.

A more efficacious method for determining the level of biological activity in a boiler system is needed, as well as a technique for pinpointing or locating areas of high biological activity. In conjunction with this method, a control strategy for minimizing or eliminating biological activity, which is adverse to the integrity of a boiler system, needs to be addressed.

### SUMMARY OF THE INVENTION

The present invention provides for a method of monitoring and optionally controlling the biological activity in a boiler condensate and/or feedwater system comprising: (a) collecting one or more samples of fluid from said boiler condensate and/or feedwater system; (b) treating the sample with a surfactant; (c) adding luciferin and luciferase to said sample treated with said surfactant; (d) measuring the amounts of total and/or free ATP in said sample from step (c) with one or more photometers; (e) correlating the amount of ATP with biological activity in said boiler condensate and/or feedwater system; and (f) optionally controlling the biological activity by adding one or more chemicals to said boiler condensate and/or feedwater system.

### DETAILED DESCRIPTION OF THE INVENTION

“ATP” means adenosine triphosphate.

“Total ATP” is defined as the amount of ATP that is determined after a lysing agent is added to a sample of fluid.

“Free ATP” is defined as the ATP in the fluid before applying a lysing agent.

Various surfactants can be utilized to lyse the bacteria cells.

In one embodiment, the surfactant is ethylendiaminetetraacetic acid (EDTA).

Various chemicals are utilized to treat biological activity/microbial fouling in boiler condensate and/or feedwater systems. Often times, the chemicals applied to a boiler condensate and/or feedwater systems need to be approved by the Food and Drug Administration (FDA) or other regulatory bodies, including those in the United States and around the world.

In one embodiment, the chemicals are selected from the group consisting of: oxidizing biocides, non-oxidizing biocides, and a combination thereof.

The samples collected from the boiler condensate and/or feedwater systems can occur at various locations in the boiler system.

In one embodiment, the samples are collected in an area of said boiler condensate and/or feed water system when said fluid is at a temperature of between 120° F. to 200° F.

In another embodiment, the samples are collected from an area of said boiler condensate and/or feed water system that excludes a holding tank of a condensate-return line from said boiler condensate system and/or feed water system.

One or more samples can be collected. This facilitates creating a profile of biological activity so that a treatment program can be developed to prevent biofouling/biological activity in condensate and/or feedwater systems. By studying more than one sample, one of ordinary skill in the art can identify the areas of biological activity and more specifically areas of higher biological activity.

In one embodiment, a profile of said biological activity is made from a plurality of sample measurements that are collected from a plurality of locations of said boiler condensate and/or feedwater system; and optionally creating a chemical feed strategy to control the biological activity in one or more regions of said boiler condensate and/or feedwater system.

### EXAMPLE SECTION

Condensate samples were collected from various locations of a boiler system. The table below shows ATP and bacterial viability in three samples collected from various boiler system locations from a condensate return line before the storage tank. ATP was measured by a photometer in RLU units; RLU stands for relative light unit, which is the luminescence intensity of ATP measured by, in this case, a Nalco Company TRA-CIDE ATP photometer. Other photometers can be utilized.

The bacterial viability was determined by plate count enumeration on different selective media, and expressed as colony forming unit (CFU). The results show that no viable bacteria were detected in either sample. The preliminary survey results showed that out of seven main condensate lines only one (line#2) showed a significantly high ATP reading. From all the building complexes that contributed to line #2, Complex G (labeled as 2-G in table below) had a significant amount of total and cellular ATP. Microbes released the cellular ATP when the cell membrane was ruptured. The amount of ATP that remains in the water for several hours before it is degraded is often considered as free ATP. When measuring the ATP level in a water sample without the usage of lysing agent to break down the cell membrane, the reading is considered to be free ATP. The difference between total and free ATP is considered as cellular ATP. The high levels of cellular and total ATP in the first two sample locations is evident of biofouling (see Table below). The biofilm formed on the pipe surface provides a thermal insulation for microbes to survive in the extreme heat within the condensate system. Due to sloughing of the biofilm, the bacteria were released to bulk water and showed high levels of total and cellular ATP.

| | Total ATP | Cellular ATP | Viability |
|---|---|---|---|
| Sample Location | (RLU/ml) | (RLU/ml) | (CFU/ml) |
| Main Condensate | 10,930 | 10,800 | <100 |
| Line #2 | | | |
| Building | 358 | 301 | <100 |
| Complex 2-G | | | |
| Main Condensate | 32 | 15 | <100 |
| Line #4 | | | |

Since there is rarely any viable cells in the condensate sample, the plate count enumeration could not detect any viable cells. However, the ATP assessment provides us a clue of possible microbial fouling when utilized to survey the condensate and feed water.

We claim:

1. A method of monitoring and optionally controlling the biological activity in a boiler condensate and/or feedwater system comprising:
a. collecting one or more samples of fluid from said boiler condensate and/or feedwater system;
b. treating the sample with a surfactant;
c. adding luciferin and luciferase to said sample treated with said surfactant;
d. measuring the amounts of total and/or free adenosine triphosphate (ATP) in said sample from step (c) with one or more photometers;
e. correlating the amount of ATP with biological activity in said boiler condensate and/or feedwater system;
f. optionally controlling the biological activity by adding one or more chemicals to said boiler condensate and/or feedwater system.

2. The method of claim 1, wherein said chemicals are selected from the group consisting of: oxidizing biocides, non-oxidizing biocides, and a combination thereof.

3. The method of claim 1, wherein said samples are collected in an area of said boiler condensate and/or feed water system when said fluid is at a temperature of between 120° F. to 200° F.

4. The method of claim 1, wherein the samples are collected from an area of said boiler condensate and/or feed water system that excludes a holding tank of a condensate-return line from said boiler condensate system and/or feed water system.

5. The method of claim 1, wherein a profile of said biological activity is made from a plurality of sample measurements that are collected from a plurality of locations of said boiler condensate and/or feedwater system; and optionally creating a chemical feed strategy to control the biological activity in one or more regions of said boiler condensate and/or feedwater system.
